(19) United States
(12) Patent Application Publication
(10) Pub. No.: US 2006/0093901 A1
(43) Pub. Date: May 4, 2006

(54) Secondary battery module and cooling apparatus for secondary battery module

(76) Inventors: Gun-Goo Lee, Suwon-si (KR); Yoon-Cheol Jeon, Suwon-si (KR); Tae-Yong Kim, Suwon-si (KR); Kyeong-Beom Cheong, Suwon-si (KR)

Correspondence Address: CHRISTIE, PARKER & HALE, LLP, PO BOX 7068, PASADENA, CA, 91109-7068, US

(21) Appl. No.: 11/256,337

(22) Filed: Oct. 20, 2005

(30) Foreign Application Priority Data
Oct. 28, 2004 (KR) 10-2004-0086604
Oct. 28, 2004 (KR) 10-2004-0086605
Oct. 28, 2004 (KR) 10-2004-0086642

(51) Int. Cl. H01M 10/50; H01M 2/12

(52) U.S. Cl. 429/120; 429/148; 429/62; 429/83; 429/71

(57) ABSTRACT

A battery module with a cooling system capable of ventilating a uniform amount of air through the respective unit cells. The battery module includes a plurality of unit cells spaced from each other and a housing for accommodating the unit cells therein. The housing has an inflow guide side inclined with respect to the direction perpendicular to the interfacial surfaces of the plurality of unit cells, an air inlet for introducing a temperature controlling air, and an air outlet for discharging the air ventilated through the unit cells.

### CROSS-REFERENCE TO RELATED APPLICATION

This application claims priority to and the benefit of Korean Patent Application Nos. 10-2004-0086604, 10-2004-0086605, and 10-2004-0086642 filed with the Korean Intellectual Property Office on Oct. 28, 2004, the entire content of which is incorporated herein by reference.

### BACKGROUND OF THE INVENTION

1. Field of the Invention

The present invention relates to a secondary battery, and in particular, to a secondary battery module having a cooling system for cooling the secondary battery module.

2. Description of Related Art

Generally, secondary batteries are based on a rechargeable mechanism which is distinguished from that of primary cells where only the irreversible conversion of chemical to electrical energy is made. Secondary batteries may be classified into low-capacity batteries and high-capacity batteries. Low-capacity batteries are used as the power supply for small portable electronic devices, such as cellular phones, notebook computers, and camcorders, whereas high-capacity batteries are used as the power supply for driving motors in hybrid electric vehicles and the like.

Secondary batteries may be various shapes, such as a cylindrical shape or a prismatic shape. In order to drive a motor for the electric vehicle requiring high electrical power, a plurality of high-capacity secondary batteries are serially connected to each other to form a high-capacity secondary battery.

High-capacity secondary batteries (“battery module”) are constructed by serially interconnecting a plurality of secondary batteries (“unit cells”). The respective unit cells include an electrode assembly with positive and negative electrode plates having a separator interposed therebetween, and a case for mounting the electrode assembly therein. A cap assembly is fitted to the case to seal the case, and positive and negative electrode terminals are electrically connected to current collectors of the positive and the negative electrode plates of the electrode assembly respectively.

With a conventional prismatic battery, unit cells are cross-arranged such that the positive and negative electrode terminals thereof protruding from the top of each cap assembly alternate with those of neighboring unit cells. A conductor interconnects the screwed negative and positive electrode terminals via a nut, thereby constructing a battery module.

Since the battery module is constructed by interconnecting several to tens of unit cells, it is desirable for heat generated by the unit cells to be dissipated without difficulty. Moreover, for secondary batteries used in a hybrid electric vehicle (HEV), heat dissipation is one of the most critical matters.

If heat is not dissipated properly, the heat generated from the unit cells may induce unacceptable temperature elevation of the battery module. As a result, the battery module may malfunction.

Particularly because an HEV battery module is charged and discharged by high electric current, heat is generated due to an internal reaction of the secondary battery, and the temperature may be elevated to a considerable degree. This severely affects the intrinsic characteristic of the battery, and deteriorates the intrinsic capacity thereof.

Furthermore, the internal pressure of the battery may be elevated due to the internal chemical reaction of the battery, and accordingly, the shape of the battery may become distorted, severely affecting the intrinsic characteristics of the battery. Particularly when the ratio of the width to the length of the secondary battery is high, as in a prismatic secondary battery, such a risk is increased.

In a conventional battery module, a cell barrier is disposed between neighboring unit cells to secure space for ventilating a cooling air through the unit cells. When unit cells are mounted within a housing, cooling air is introduced into the housing to control the temperature of the unit cells, and ventilated through the cell barriers, thereby dissipating heat generated from the unit cells.

However, with the conventional way of cooling, the amount of cooling air ventilated through respective cell barriers is not uniform, causing a temperature deviation among the unit cells. Accordingly, with a conventional battery module, the heat generated from the respective unit cells is not dissipated uniformly, deteriorating the charging and discharging efficiency of the battery module.

### SUMMARY OF THE INVENTION

According to one embodiment of the present invention, a battery module includes a plurality of unit cells spaced from each other, and a housing for accommodating the unit cells therein. The housing has an inflow guide inclined with respect to the direction perpendicular to the interfacial surfaces of the plurality of unit cells, an air inlet for introducing a temperature controlling air, and an air outlet for discharging the air ventilated through the unit cells.

The air inlet of the housing has a one-sided inlet hole, and the inflow guide of the air inlet tapers toward the unit cells distally from the air inlet.

The air inlet of the housing has an inlet hole for introducing the temperature controlling air perpendicularly to the interfacial surfaces of the plurality of unit cells.

The inflow guide side of the air inlet is inclined at about 15-75° with respect to the direction proceeding perpendicular to the interfacial surfaces of the plurality of unit cells, and, in one exemplary embodiment, at 15-45° with respect thereto.

A cell barrier is disposed between the neighboring unit cells to space the unit cells from each other, and an air ventilation channel is formed at the cell barrier to ventilate the temperature controlling air. The sectional area of the respective unit cell barriers is uniformly formed, and the air with a uniform flow speed is ventilated through the air ventilation channels.

The air inlet of the housing has an inlet hole one-sidedly opened, and the air outlet of the housing comprises an outlet hole opened in the same direction as the inlet hole. The direction of the air inflow through the inlet hole is opposite to the direction of the air outflow through the outlet hole.

The air outlet has an outlet hole for discharging the temperature controlling air parallel to the direction proceeding perpendicular to the interfacial surfaces of the unit cells. The air outlet has an outflow guide side formed parallel to the direction proceeding perpendicular to the interfacial surfaces of the plurality of unit cells.

Alternatively, the air outlet may have an outflow guide side inclined with respect to the direction proceeding perpendicular to the interfacial surfaces of the plurality of unit cells. The outflow guide side of the air outlet is inclined such that the outflow guide side goes far from the outlet hole, it comes closer to the unit cells.

According to another aspect of the present invention, the air inlet of the housing has an inlet hole one-sidedly opened, and the air outlet of the housing has an outlet hole opened opposite to the inlet hole.

According to still another aspect of the present invention, the air inlet of the housing has an inlet hole one-sidedly opened, and the air outlet of the housing has an outlet hole opened parallel to the interfacial surfaces of the plurality of unit cells.

The air outlet of the housing has an outflow guide side inclined from the periphery to the center, and is reduced in the sectional area thereof as it goes far from the unit cells such that the air ventilated through the respective unit cells are collected to the center, and discharged.

The air outlet of the housing may have an outflow guide side inclined from the periphery at the front and rear of the arrangement of the unit cells to the center, and be reduced in the variable sectional area thereof as it goes far from the unit cells.

Furthermore, the air outlet of the housing may have an outflow guide side inclined from the periphery at the left and right of the arrangement of the unit cells to the center, and be reduced in the variable sectional area as it goes far from the unit cells.

According to still another aspect of the present invention, the cooling system for a battery module includes a housing for accommodating a plurality of unit cells arranged with a predetermined distance therein, and a coolant supplier for dissipating the heat generated from the respective unit cells by supplying a temperature controlling air to the interior of the housing. The housing has an air ventilator for ventilating a uniform amount of air through the respective unit cells.

The air ventilator has an inflow guide side inclined with respect to the arrangement of the plurality of unit cells, an air inlet for introducing the temperature controlling air, and an air outlet for discharging the air ventilated through the unit cells.

### BRIEF DESCRIPTION OF THE DRAWINGS

FIG. 1 is a schematic perspective view of a battery module according to one embodiment of the present invention.

FIG. 2 is a schematic side elevation view of the battery module according to the embodiment of the present invention as shown in FIG. 1.

FIG. 3 is a perspective view of a unit cell assembly for the battery module according to the embodiment of the present invention as shown in FIG. 1.

FIG. 4 is a perspective view of unit cell assembly for the battery module according to another embodiment of the present invention.

FIG. 5 is a schematic side elevation view of a battery module according to yet another embodiment of the present invention.

FIG. 6 is a schematic perspective view of a battery module according to still another embodiment of the present invention.

FIG. 7 is a schematic side elevation view of the battery module according to the embodiment of the present invention as shown in FIG. 6.

FIG. 8 is a schematic side elevation view of a battery module according to another embodiment of the present invention.

FIG. 9 is a schematic perspective view of a battery module according to yet another embodiment of the present invention.

FIG. 10 is a schematic side elevation view of the battery module according to the embodiment of the present invention as shown in FIG. 9.

FIG. 11 is a schematic perspective view of a battery module according to still another embodiment of the present invention.

FIG. 12 is a block diagram illustrating the usage of a battery module as a driving motor.

### DETAILED DESCRIPTION

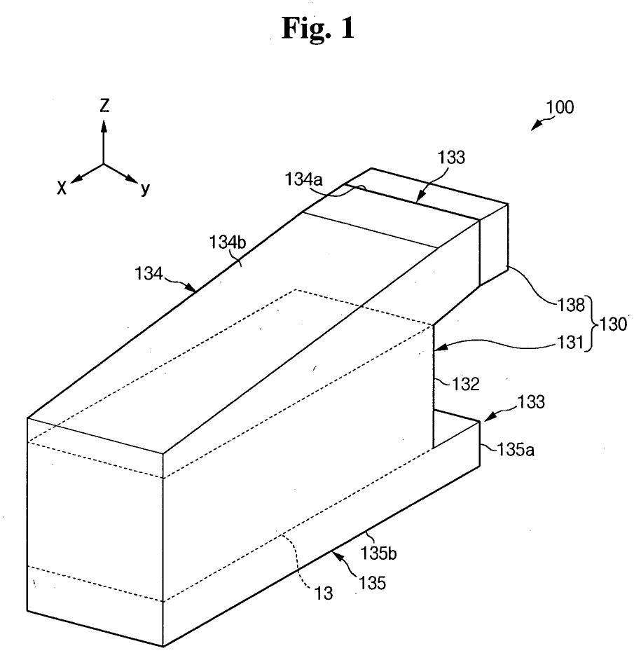

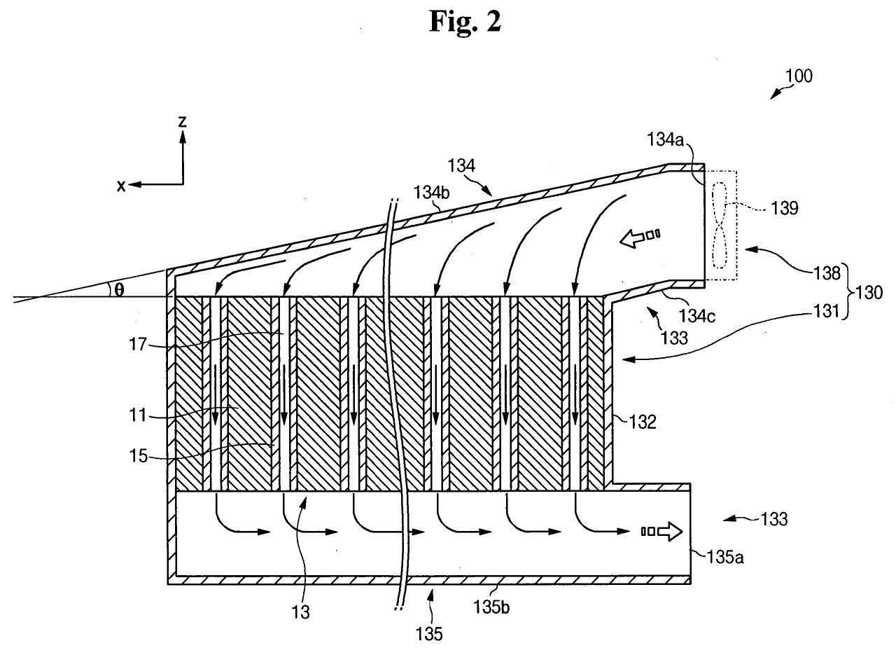

As shown in FIGS. 1 and 2, the battery module 100 according to the present embodiment is a high-capacity battery module, and includes a plurality of unit cells 11 serially arranged and spaced from each other.

In this embodiment, each unit cell has a secondary battery having an electrode assembly including positive and negative electrode plates interposed with a separator to charge and discharge electric power.

A cell barrier 15 is provided between the neighboring unit cells 11 as well as between the outermost unit cell 11 and the wall of the housing 131 to maintain the distance between the unit cells 11 and to support the sidewall of each unit cell 11. An air ventilation channel 17 is formed at the respective cell barriers 15 to ventilate a cooling air with a relatively low temperature through the unit cells 11.

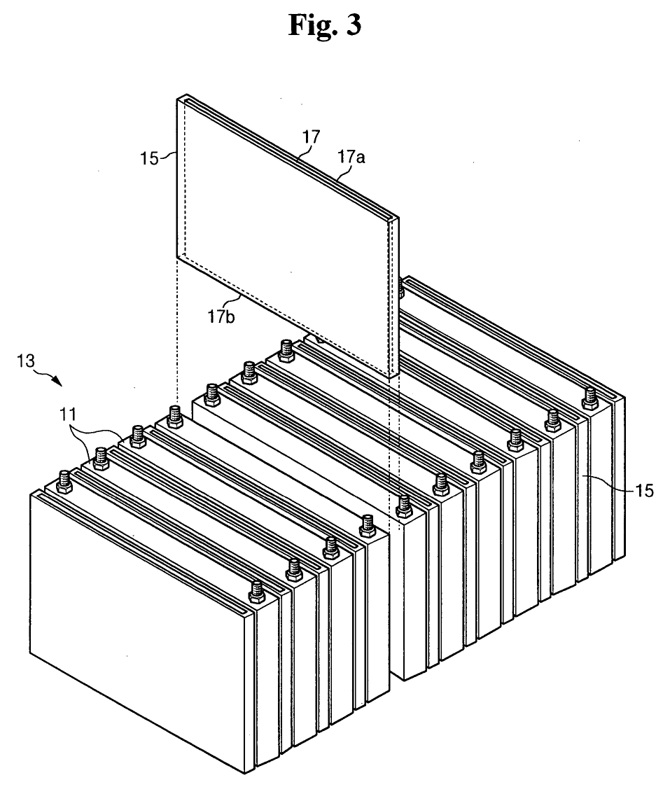

As shown in FIG. 3, the air ventilation channels 17 may be formed with at least one breakthrough hole spanning from edge 17a to edge 17b of the cell barrier 15, the hole having a uniform sectional area. Accordingly, with the battery module 100, a plurality of unit cells 11 are serially arranged spaced from each other while being insulated from each other by cell barriers 15, thereby forming a unit cell assembly 13 capable of ventilating the temperature controlling air through the unit cells 11.

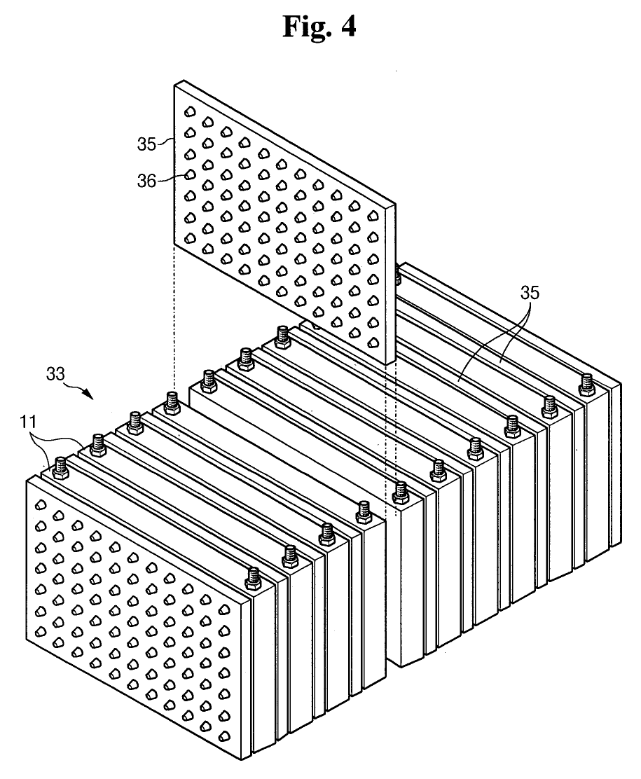

As shown in FIG. 4, an alternate unit cell assembly 33 includes a plurality of protrusions 36 such that a gap is formed between the cell barrier 35 and the neighboring unit cell 11 to ventilate the cooling air. The protrusions 36 may be attached to the cell barrier 35, such as by an adhesive, or integrated with a body, such as by the process of embossing or drawing. Furthermore, it is possible to form the protrusions 36 only one side of the cell barrier 35, or on both sides thereof.

When the protrusions 36 are formed on the cell barrier 35, an air ventilation channel is formed between the cell barrier 35 and the neighboring unit cell 11 so that the cooling air can be ventilated through the gap, thereby allowing effective heat dissipation.

Alternatively, grooves may be linearly formed at the surface of the cell barrier along the direction of air ventilation, thereby forming convex and concave portions as the air ventilation channel.

Referring to FIGS. 1-4, the battery module 100 according to the present embodiment is provided with a cooling unit 130. The cooling unit 130 receives the unit cell assembly 13, and ventilates the temperature controlling air through the air ventilation channel 17 disposed between neighboring unit cells 11, thereby dissipating heat generated from the unit cells 11.

The cooling unit 130 includes a housing 131 for accommodating the unit cell assembly 13 and ventilating a predetermined amount of temperature controlling air to the air ventilation channel 17 of the respective unit cells 11, and a coolant supplier 138 for supplying the temperature controlling air to the interior of the housing 131.

The housing 131 includes a receptor 132 for receiving the unit cell assembly 13, and a ventilator 133 for ventilating a predetermined amount of temperature controlling air through the air ventilation channels 17 disposed between the neighboring unit cells 11.

The receptor 132 receives the unit cell assembly 13, and fixedly holds it therein. The ventilator 133 serves to uniformly distribute the temperature over the entire area of the unit cell assembly 13 by improving the structure of ventilating the temperature controlling air through the air ventilation channels 17 disposed between neighboring unit cells 11.

The ventilator 133 includes an air inlet 134 provided at a first side of the receptor 132 to introduce a temperature controlling air into the receptor 132, and an air outlet 135 provided at a second side of the receptor 132 to discharge the air ventilated through the respective unit cells 11 within the receptor 132 to the outside.

The air inlet 134 and the air outlet 135 may be formed together at the receptor 132 such that the inflow direction of the air introduced into the receptor 132 by the coolant supplier 138 is opposite to the outflow direction of the air ventilated through the respective unit cells 11 and discharged to the outside of the receptor 132.

That is, the air inlet 134 has a one-way inlet hole 134a to introduce the temperature controlling air from the coolant supplier 138 perpendicular to the interfacial surfaces of the unit cells 11. The air outlet 135 has an outlet hole 135a for discharging the air ventilated through the respective unit cells 11 parallel to the arrangement of the unit cells 11 and opposite to the inflow direction of the temperature controlling air. Accordingly, the openings of inlet hole 134a and the outlet hole 135a face the same direction.

In this embodiment, the air inlet 134 has an inflow guide side 134b inclined with respect to the air inflow, and thus, inclined with respect to the arrangement of the unit cells 11. Specifically, the inflow guide side 134b tapers toward the unit cells 11 in the direction away from the inlet hole 134a. The inclination angle θ of the inflow guide side 134b may be between about 15-75° with respect to the arrangement of the unit cells 11, and in one exemplary embodiment, may be between about 15-45°.

When the inclination angle θ of the inflow guide side 134b is less than about 15° or greater than about 45°, the air pressure degradation degree is minimized such that a uniform amount of air flow cannot be ventilated through the air ventilation channel 17. When the inclination angle E of the inflow guide side 134b exceeds 75°, the air speed accelerating effect decreases so as to cause a temperature deviation at the respective unit cells 11, and the air is not uniformly distributed over the entire area of the unit cell group 13.

An inner guide side 134c guides the air introduced through the inlet hole 134a together with the inflow guide side 134b. The inner guide side 134c may be placed parallel to the inflow guide side 134b, or the inlet hole 134a may be widened or narrowed by controlling the inclination angle.

In this embodiment, the air introduced through the inlet hole 134a reaches the inflow guide side 134b inclined at a predetermined angle, and flows along the inflow guide side 134b to the top of the unit cells. The inflow guide side 134b tapers toward the unit cells 11 in the direction away from the inlet hole 134a. Therefore, the sectional area of the air flow gradually decreases away from the inlet hole 134a. In this process, the air flow speed is gradually accelerated by way of the continuity equation of fluid mechanics (the fluid flow per unit time is constant at any sectional area, and hence, the value of the sectional area multiplied by the speed of the fluid flowing the section is constant) as the air flows away from the inlet hole 134a. As known from Bernoulli's theorem (when the fluid flow speed is increased, the pressure is decreased, whereas when the fluid flow speed is decreased, the pressure is increased), the air flow speed is increased as it flows away from the inlet hole 134a, and the air pressure is gradually decreased. At this time, the speed of the air flow ventilated through the air ventilation channels 17 disposed between neighboring unit cells 11 is decreased.

Accordingly, the air introduced through the inlet hole 134a passes through the air ventilation channels 17 disposed between the neighboring unit cells 11 at a predetermined speed. When the sectional areas of the air ventilation channels 17 are uniformly formed, a uniform amount of air may be ventilated through the respective air ventilation channels 17 by way of the above-described continuity equation.

Therefore, with the battery module 100 according to the present embodiment, a uniform amount of air is ventilated through the air ventilation channels 17 disposed between the neighboring unit cells 11 so that the heat generated from the respective unit cells 11 is dissipated properly, and accordingly, the temperature is uniformly distributed over the entire area of the unit cell group 13.

The air ventilated through the air ventilation channels 17 is discharged through the air outlet 135, which has an outflow guide side 135b placed parallel to the arrangement of the unit cells 11 and the air outflow.

The air ventilated through the air ventilation channels 17 reaches the outflow guide side 135b, flows along the outflow guide side 135b, and is discharged through the outlet hole 135a.

As indicated in phantom in the drawing, the coolant supplier 138 for supplying the temperature controlling air to the interior of the housing 131 may have a fan 139 installed at the inlet hole 134a of the housing 131 to propel the air into the interior of the housing 131 through the inlet hole 134a. Various fans such as a propeller fan and a sirocco fan may be used as the fan 139. Alternatively, the coolant supplier 138 may be provided with a pump or blower capable of blowing air, irrespective of the presence of the fan 139. Furthermore, in the case of automobile usage, the forceful convection current generated during the driving may be used together with a blower of another system (such as a compressor fan or radiator fan of the car air conditioning system).

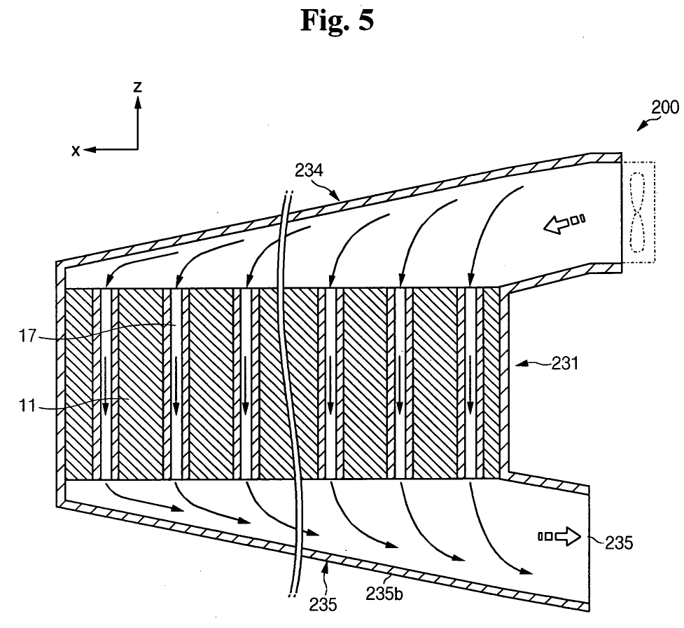

FIG. 5 is a schematic side elevation view of a battery module according to a second embodiment of the present invention.

As shown in FIG. 5, the battery module according to the present embodiment includes an air outlet 235 for fluently discharging the air introduced into the housing 231 through the air inlet 234 and ventilated through the air ventilation channels 17 disposed between the neighboring unit cells 11 to the outside.

In this embodiment, the air outlet 235 is provided with an outflow guide side 235b inclined with respect to the arrangement of the unit cells 11 and the air outflow. The outflow guide side 235b is inclined such that as the outflow guide side 235b tapers away from the unit cells 11 in the direction towards the air outlet.

The air ventilated through the air ventilation channels 17 reaches the outflow guide side 235b, flows along the outflow guide side 235b, and is discharged through the outlet hole 235a.

Other structural components and operation of the battery module 200 according to the present embodiment are the same as those related to the above-described embodiments, and detailed explanation thereof will be omitted.

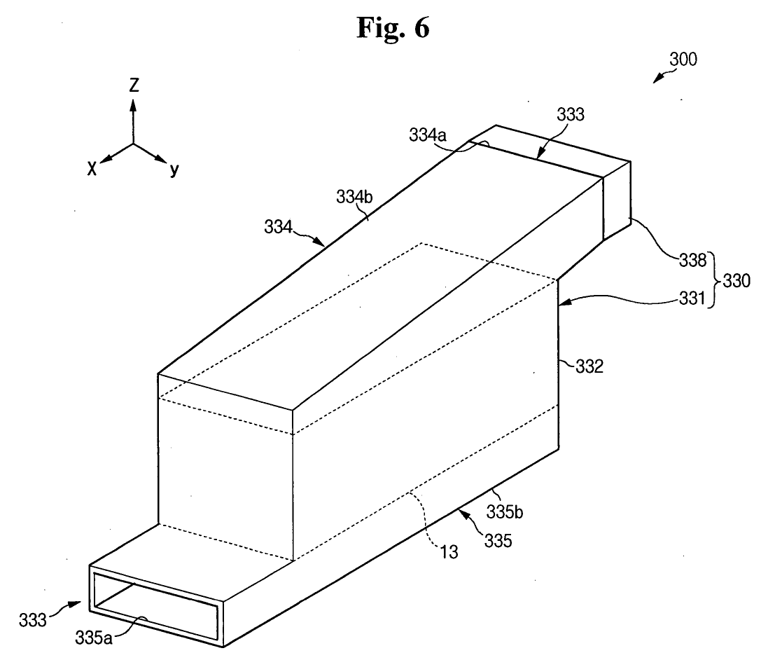

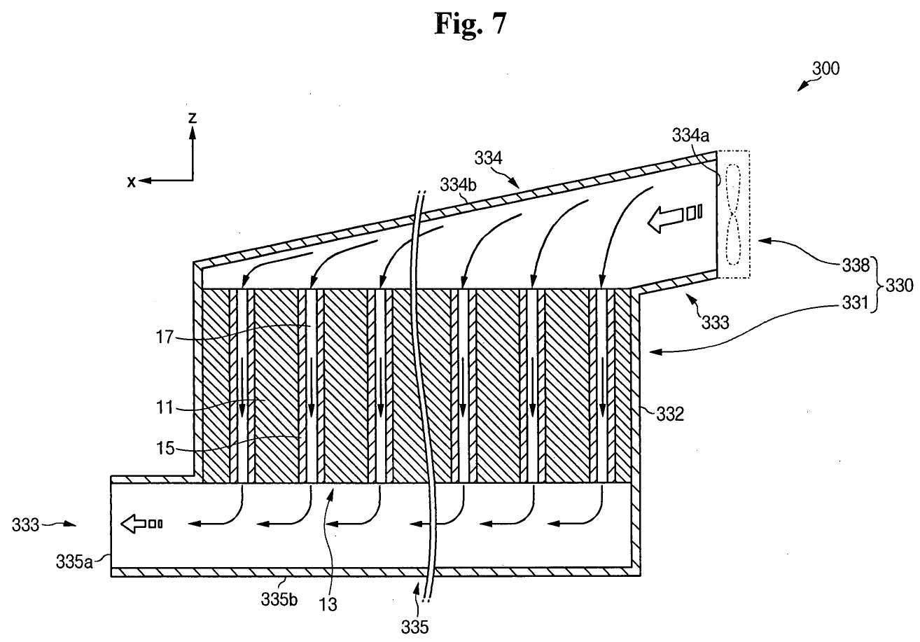

FIG. 6 is a schematic perspective view of a battery module according to another embodiment of the present invention, and FIG. 7 is a schematic side elevation view of the battery module according to the embodiment as shown in FIG. 6.

As shown in FIGS. 6-7, the battery module 300 includes a unit cell assembly 13 and a cooling unit 330. The cooling unit 330 includes a housing 331 for accommodating the unit cell assembly 13 and ventilating a predetermined amount of temperature controlling air through the air ventilation channels 17 of the respective unit cells 11, and a coolant supplier 338 for supplying the temperature controlling air to the interior of the housing 331.

The housing 331 includes a receptor 332 for receiving the unit cell assembly 13, and an air ventilator 333 for ventilating a predetermined amount of temperature controlling air through the air ventilation channels 17 disposed between the neighboring unit cells 11.

The air ventilator 333 includes an air inlet 334 provided at a first side of the receptor 332 to introduce the temperature controlling air into the receptor 332, and an air outlet 335 provided at a second side of the receptor 332 to discharge the air ventilated through the respective unit cells 11 within the receptor 332.

In this embodiment, the air inlet 334 and the air outlet 335 may be provided at the receptor 332 such that the inflow direction of the air introduced into the receptor 332 and the outflow direction of the air ventilated through the unit cells 11 and discharged to the outside of the receptor 332 are the same.

That is, the air inlet 334 has a one-way inlet hole 334a to introduce the temperature controlling air from the coolant supplier 338 to the arrangement of the unit cells 11 (in the direction of the x axis of the drawing). The air outlet 335 has an outlet hole 335a for discharging the air ventilated through the respective unit cells 11 parallel to the arrangement of the unit cells 11 and in the direction of the air inflow. Accordingly, the openings of inlet hole 334a and the outlet hole 335a are opposite each other.

The air ventilated through the air ventilation channels 17 is charged through the air outlet 335, which has an outflow guide side 335b placed parallel to the arrangement of the unit cells 11 and the air outflow.

The air ventilated through the air ventilation channels 17 reaches the outflow guide side 335b, flows along the outflow guide side 135b, and is discharged to the outside of the housing 331 through the outlet hole 335a.

In this embodiment, the shape and features of the air inlet 334 are the same as those related to the above-described embodiments, and detailed explanation thereof will be omitted.

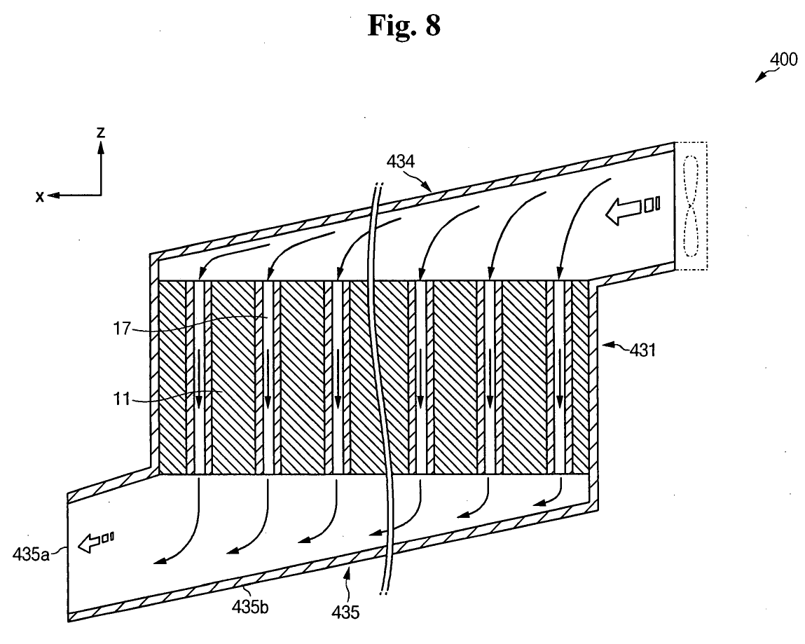

FIG. 8 is a schematic side elevation view of a battery module according to yet another embodiment of the present invention.

As shown in FIG. 8, the battery module 400 according to the present embodiment includes an air outlet 435 for fluently discharging the air introduced into the housing 431 through the air inlet 434 and ventilated through the air ventilation channels 17 disposed between the neighboring unit cells 11 to the outside of the housing 431.

In this embodiment, the air outlet 435 has an outflow guide side 435b inclined with respect to the arrangement of the unit cells 11. The outflow guide side 435 is inclined such that as the outflow guide side 435 tapers toward the unit cells 11 in a direction away from the outlet hole 435a.

Consequently, the air ventilated through the air ventilation channels 17 reaches the outflow guide side 435b, flows along the outflow guide side 435b, and is fluently discharged through the outlet hole 435a.

Other structural components and operation of the battery module 400 are the same as those related to the embodiments of FIGS. 6-7, and detailed explanation thereof will be omitted.

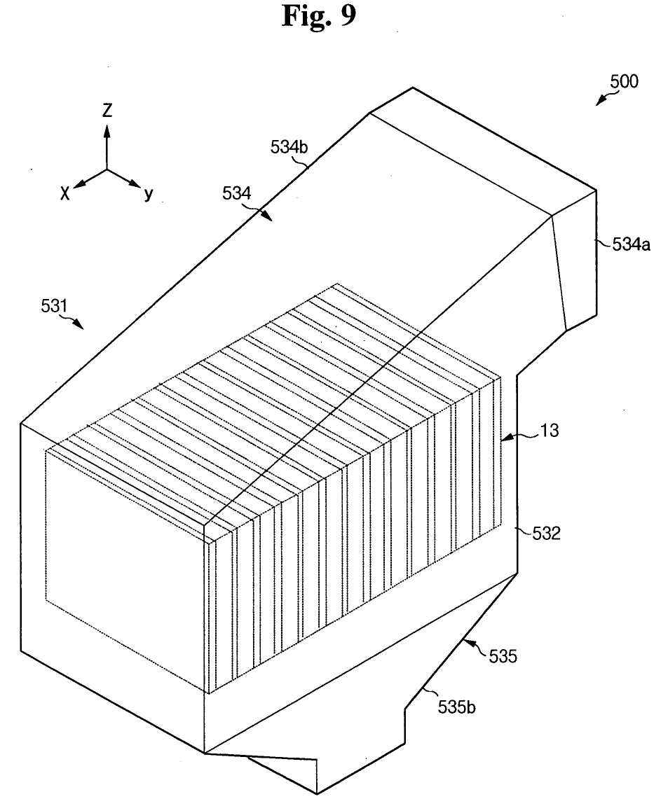

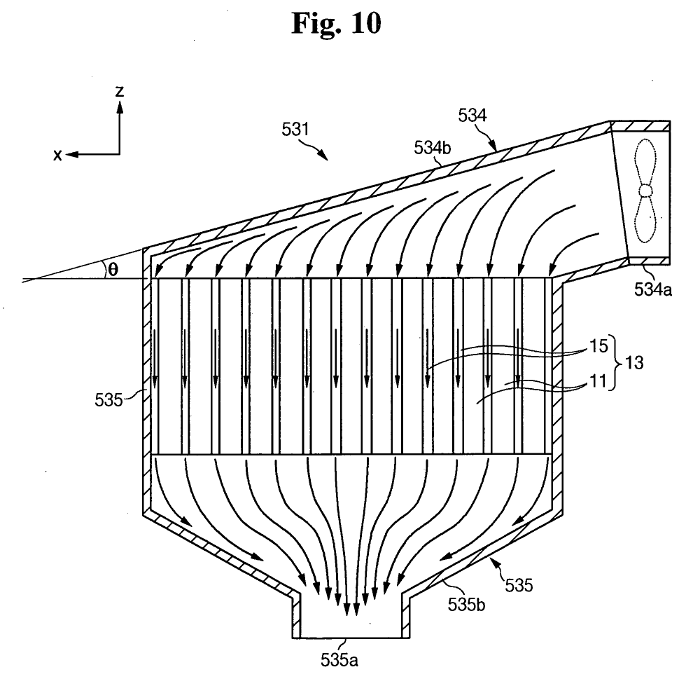

FIG. 9 is a schematic perspective view of a battery module according to yet another embodiment of the present invention, and FIG. 10 is a schematic side elevation view of the battery module according to the embodiment as shown in FIG. 9.

As shown in the drawings, the battery module 500 includes a housing 531 with an air inlet 534 placed at the one-sided portion thereof to introduce a temperature controlling air and an air outlet 535 placed at the other-sided portion thereof to discharge the air, and a plurality of unit cells 11 laminated within the housing 531. A plurality of cell barriers 15 are disposed between the unit cells 11 to ventilate the air.

The unit cells 11 and the cell barriers 15 are alternately laminated to thereby construct a unit cell assembly 13, which is fixedly mounted within the housing 531.

The housing 531 includes a receptor 532 for receiving the unit cell assembly 13 where the unit cells 11 and the cell barriers 15 are alternately laminated, an air inlet 534 connected to the one-sided portion of the receptor 532 to introduce the air for controlling the temperature of the respective unit cells 11, and an air outlet 535 connected to the other-sided portion of the receptor 532 opposite to the air inlet 534 to discharge the air ventilated through the respective unit cells 11.

The air inlet 534 of the housing 531 is formed such that the air is introduced therethrough in the direction inclined with respect to the arrangement of the unit cells 11.

The inlet hole 534a of the air inlet 534 may be formed parallel to the arrangement of the unit cells 11 (in the direction of the x axis of the drawing), or inclined with respect to the arrangement of the unit cells at an inclination angle θ that prevents air introduced through the inlet hole 534a from being directly channeled to the unit cells 11. When air introduced through the inlet hole 534a is directly channeled to the unit cells 11, the amount of air flow may be partially uneven.

The air inlet 534 of the housing 531 has an inflow guide side 534b inclined towards the receptor 532 farthest from the inlet hole 534a.

The inflow guide side 534b is inclined such that as the inflow guide side 534b proceeds away from the inlet hole 534a along the arrangement of the unit cells 11, the inflow guide side 534b tapers toward the unit cells 11.

In one exemplary embodiment, the point of connection of the inflow guide side 534 to the receptor 532 from the end of the unit cells 11 allowing the desired amount of air flow to be ventilated through the air ventilation channels disposed between the unit cells 11 spaced from the inlet hole 534a.

Other structural components and operation of the air inlet 534 according to the present embodiment are the same as those related to the embodiments of FIGS. 1-4, and detailed explanation thereof will be omitted.

The air outlet 535 of the housing 531 has an outflow guide side 535b formed with an inclined surface tapered toward a central unit cell 11 such that the air ventilated through the unit cells 11 is collected at the center, and discharged. An outlet hole 535a is formed at the end of the outflow guide side 535b to discharge the air. Accordingly, the outlet hole 535a is opened parallel to the interfacial surfaces of the plurality of unit cells 11.

As shown in FIGS. 9 and 10, with the air outlet 535, the outflow guide side 535b placed at the front and rear of the arrangement of the unit cells 11 is inclined at a predetermined angle, and its sectional area is reduced in the direction away from the unit cells 11.

Therefore, the air ventilated through the respective unit cells 11 is discharged at a gradually increased rate, allowing the air to be discharged in a fluent manner.

The starting point of the outflow guide side 535b of the air outlet 535 may be spaced from the end of the unit cells 11 so that the air flow streams ventilated through the respective unit cells 11 proceed parallel to each other within a predetermined section, and do not unnecessarily affect the air flow ventilated through the unit cells 11.

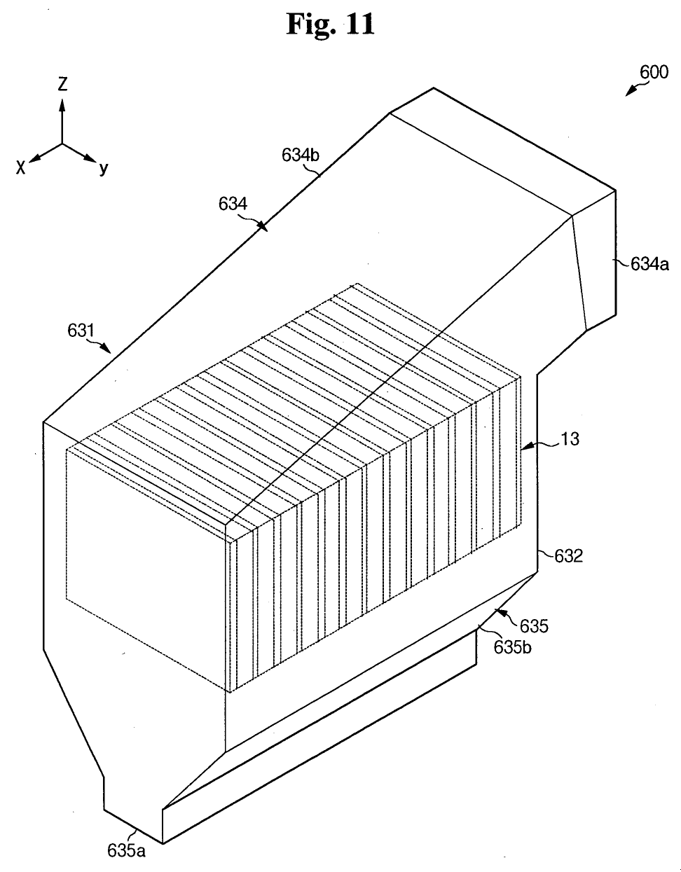

FIG. 11 is a schematic perspective view of a battery module according to yet another embodiment of the present invention.

As shown in FIG. 11, with the battery module 600 according to the present embodiment, the air outlet 635 has an outflow guide side 635b with an inclined surface inclined from the periphery at the left and right of the arrangement of the unit cells 11 to the center, which reduces the sectional of the air outlet in a direction away from the unit cells 11.

In this embodiment, other structural components and operation of the battery module are the same as those related to the embodiments of FIGS. 9-10, and detailed explanation thereof will be omitted.

It is explained in relation to the embodiments pertaining to FIGS. 9-11 of the present invention that both outflow guide sides of the air outlet are formed with an inclined surface, but all four outflow guide sides may also be formed with the inclined surface.

The battery module according to the present invention is effectively used as the power supply for driving motors in hybrid electric vehicles (HEV), electric vehicles (EV), wireless cleaners, electric bicycles, electric scooters and the like. Furthermore, it is variously used to satisfy the high power/high capacity requirement.

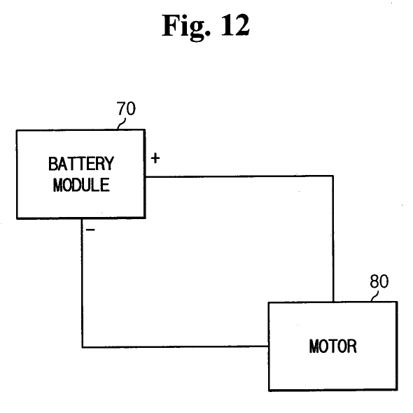

FIG. 12 is a block diagram illustrating the usage of a battery module 70 as a driving motor 80.

As described above, in accordance with the battery module according to the present invention, the air ventilation structure of the housing is improved such that a predetermined amount of air is ventilated through the air ventilation channels disposed between the neighboring unit cells, and hence, the temperature is uniformly distributed over the entire area of the unit cell assembly. Consequently, the cooling efficiency of the unit cell assembly is optimized, and the charging and discharging efficiency of the battery module is further enhanced.

Although exemplary embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. A battery module comprising:
a plurality of unit cells spaced from each other; and
a housing for accommodating the plurality of unit cells therein;
wherein the housing includes an inflow guide inclined with respect to interfacial surfaces of the plurality of unit cells, an air inlet for introducing a temperature controlling air, and an air outlet for discharging the temperature controlling air ventilated through the unit cells.

2. The battery module of claim 1,
wherein the air inlet of the housing includes a one-way inlet hole, and
wherein the inflow guide is inclined such that the inflow guide narrowingly tapers towards the unit cells distal from the air inlet.

3. The battery module of claim 1, wherein the air inlet of the housing includes an inlet hole for introducing the temperature controlling air into the inflow guide in a direction oblique to the interfacial surfaces of the plurality of unit cells.

4. The battery module of claim 1, wherein the inflow guide side of the air inlet is inclined between about 15-75° with respect to the interfacial surfaces of the plurality of unit cells.

5. The battery module of claim 4, wherein the inflow guide of the air inlet is inclined between about 15-45° with respect to the interfacial surfaces of the plurality of unit cells.

6. The battery module of claim 1,
wherein a cell barrier is disposed between neighboring unit cells to space the neighboring unit cells from each other, and
wherein an air ventilation channel is formed at the cell barrier to ventilate the temperature controlling air.

7. The battery module of claim 6,
wherein the sectional area of the unit cell barrier is uniformly formed, and
wherein air is ventilatable through the air ventilation channels with a uniform flow speed.

8. The battery module of claim 1,
wherein the air inlet of the housing includes a one-way inlet hole,
wherein the air outlet of the housing includes an outlet hole having an opening in the same direction as the inlet hole, and
wherein the direction of airflow through the inlet hole is opposite to the direction of airflow through the outlet hole.

9. The battery module of claim 8, wherein the air outlet includes an outlet hole for discharging the temperature controlling air in the direction oblique to the interfacial surfaces of the unit cells.

10. The battery module of claim 8, wherein the air outlet includes an outflow guide formed in a direction perpendicular to the interfacial surfaces of the plurality of unit cells.

11. The battery module of claim 8, wherein the air outlet includes an outflow guide inclined with respect to the interfacial surfaces of the plurality of unit cells.

12. The battery module of claim 11, wherein the outflow guide of the air outlet is inclined such that the outflow guide narrowingly tapers toward the unit cells distal from the air outlet.

13. The battery module of claim 1,
wherein the air inlet of the housing includes a one-way inlet hole, and
wherein the air outlet of the housing includes an outlet hole opened opposite to the inlet hole.

14. The battery module of claim 13, wherein the air outlet includes an outlet hole for discharging the temperature controlling air in a direction perpendicular to the interfacial surfaces of the unit cells.

15. The battery module of claim 13, wherein the air outlet includes an outflow guide formed in a direction perpendicular to the interfacial surfaces of the plurality of unit cells.

16. The battery module of claim 13, wherein the air outlet includes an outflow guide inclined with respect to the interfacial surfaces of the plurality of unit cells.

17. The battery module of claim 16,
wherein the outflow guide of the air outlet is inclined such that the outflow guide narrowingly tapers toward unit cells distal from the air outlet.

18. The battery module of claim 1, wherein the air inlet of the housing comprises a one-way inlet hole, and the air outlet of the housing includes an outlet hole opened parallel to the interfacial surfaces of the plurality of unit cells.

19. The battery module of claim 18, wherein the air outlet of the housing includes an outflow guide narrowingly inclined from a periphery of the unit cells to a center of the air outlet, and the sectional area of the outflow guide is reduced as the air outlet becomes distal from the unit cells such that air ventilated through the respective unit cells is centrally collected and discharged.

20. The battery module of claim 18, wherein the air outlet of the housing includes an outflow guide narrowingly inclined from a first side and an opposing side of the arrangement of the unit cells to a center of the air outlet, and the sectional area of the outflow guide is reduced as the air outlet becomes distal from the unit cells.

21. A battery module comprising:
a plurality of unit cells spaced from each other; and
a cooling unit for supplying a uniform amount of temperature controlling air to the plurality of unit cells to dissipate the heat generated by the unit cells.

22. The battery module of claim 21,
wherein a cell barrier is disposed between neighboring unit cells to space the unit cells from each other, and
wherein an air ventilation channel is formed at the cell barrier to ventilate the temperature controlling air, the air having a uniform flow speed as it is ventilated through the respective air ventilation channels.

23. A cooling system for a battery module comprising:
a housing for accommodating a plurality of unit cells spaced from each other; and
a coolant supplier for dissipating heat generated by the unit cells, the coolant supplier supplying a temperature controlling air to the interior of the housing;
wherein the housing includes an air ventilator for ventilating a uniform amount of air through the respective unit cells.

24. The cooling system for a battery module of claim 23, wherein the air ventilator includes an inflow guide inclined with respect to interfacial surfaces of the plurality of unit cells, an air inlet for introducing the temperature controlling air, and an air outlet for discharging the temperature controlling air ventilated through the unit cells.

25. The cooling system for a battery module of claim 24,
wherein the air inlet of the housing includes a one-way inlet hole, and
wherein as the inflow guide of the air inlet becomes distal from the inlet hole, the inflow guide tapers towards the unit cells.

26. The cooling system for a battery module of claim 24, wherein the air inlet of the housing includes an inlet hole for introducing the temperature controlling air parallel to interfacial surfaces the unit cells.

27. The cooling system for a battery module of claim 24, wherein the inflow guide side of the air inlet is inclined between about 15-75° with respect to the arrangement of the plurality of unit cells.

28. The cooling system for a battery module of claim 24, wherein the inflow guide side of the air inlet is inclined between about 15-45° with respect to the arrangement of the plurality of unit cells.

29. The cooling system for a battery module of claim 24,
wherein the air inlet of the housing includes one-way inlet hole,
wherein the air outlet of the housing includes an outlet hole opened in the same direction as the inlet hole, and
wherein the direction of the airflow through the inlet hole is opposite to the direction of the airflow through the outlet hole.

30. The cooling system for a battery module of claim 24,
wherein the air inlet of the housing includes a one-way inlet hole, and
wherein the air outlet of the housing includes an outlet hole opened opposite to the inlet hole.

31. The cooling system for a battery module of claim 24,
wherein the air inlet of the housing includes a one-way inlet hole one-sidedly opened, and
wherein the air outlet of the housing includes an outlet hole opened perpendicular to the plurality of unit cells
